(19) United States
(12) Patent Application Publication
(10) Pub. No.: US 2013/0324252 A1
(43) Pub. Date: Dec. 5, 2013

(54) GAME DEVICE, GAME SYSTEM, GAME CONTROL METHOD, AND INFORMATION STORAGE MEDIUM

(71) Applicant: KONAMI DIGITAL ENTERTAINMENT CO., LTD., Minato -ku, Tokyo (JP)

(72) Inventor: Kensuke YOSHITOMI, Yokohama-shi (JP)

(73) Assignee: KONAMI DIGITAL ENTERTAINMENT CO., LTD., Minato, ku, Tokyo (JP)

(21) Appl. No.: 13/905,359

(22) Filed: May 30, 2013

(30) Foreign Application Priority Data
Jun. 4, 2012 (JP) 2012-126976

(51) Int. Cl. A63F 13/00

(52) U.S. Cl. CPC A63F 13/00
USPC 463/35; 463/1

(57) ABSTRACT

A first determination unit determines whether or not an operation target of a user is included in a target region that is set based on the position of a game event occurring place. A second determination unit determines whether or not a time of determination that the operation target of the user is included in the target region is before arrival of a game event occurring time. An inducing processing execution unit executes inducing processing for inducing the user to keep the operation target of the user staying in the target region until the arrival of the game event occurring time, in a case where it is determined that the above-described time is before the arrival of the game event occurring time.

### CROSS-REFERENCE TO RELATED APPLICATION

The present application claims priority from Japanese application JP 2012-126976 filed on Jun. 4, 2012, the content of which is hereby incorporated by reference into this application.

### TECHNICAL FIELD

The present invention relates to a game device, a game system, a game control method, and an information storage medium.

### BACKGROUND ART

There is known a game in which a predetermined game event occurs at a game event occurring place set in a game space. For example, Patent Document 1 discloses a game in which a monster appears at a predetermined place in a game space.

### CITATION LIST

### Patent Literature

Patent Literature 1: JP 2010-136882 A

### SUMMARY OF INVENTION

### Technical Problem

With a game in which a predetermined game event occurs at a game event occurring place in a case where a game event occurring time arrives, a user operation target (an operation target of a user) may already leave the game event occurring place before the game event occurs in a case where the user operation target arrives at the game event occurring place before arrival of the game event occurring time. In such a case, the game event is not shown in a game screen, and therefore, the user is not aware of the game event. Being not aware of the game event, disadvantageously, the user cannot advance the game.

The present invention has been conceived in view of the above, and aims to provide a game device, a game system, a game control method, and an information storage medium capable of inducing a user to keep a user operation target staying at a game event occurring place until arrival of a game event occurring time in a case where the user operation target arrives at the game event occurring place before the arrival of the game event occurring time.

### Solution to Problem

In order to achieve the above described object, a game device according to the present invention is a game device for executing a game in which a predetermined game event occurs at a game event occurring place set in a game space in a case where a game event occurring time arrives, the game device includes operation target control means for moving an operation target of a user in the game space, based on an operation by the user, first determination means for determining whether or not the operation target of the user is included in a target region set based on a position of the game event occurring place, second determination means for determining whether or not a time of determination that the operation target of the user is included in the target region is before arrival of the game event occurring time, and inducing processing execution means for executing inducing processing for inducing the user to keep the operation target of the user staying in the target region until the arrival of the game event occurring time, in a case where it is determined that the time of determination that the operation target of the user is included in the target region is before the arrival of the game event occurring time.

Further, a game system according to the present invention is a game system for executing a game in which a predetermined game event occurs at a game event occurring place set in a game space in a case where a game event occurring time arrives, the game system includes operation target control means for moving an operation target of a user in the game space, based on an operation by the user, first determination means for determining whether or not the operation target of the user is included in a target region set based on a position of the game event occurring place, second determination means for determining whether or not a time of determination that the operation target of the user is included in the target region is before arrival of the game event occurring time, and inducing processing execution means for executing inducing processing for inducing the user to keep the operation target of the user staying in the target region until the arrival of the game event occurring time, in a case where it is determined that the time of determination that the operation target of the user is included in the target region is before the arrival of the game event occurring time.

Further, a game control method according to the present invention is a game control method for a game in which a predetermined game event occurs at a game event occurring place set in a game space in a case where a game event occurring time arrives, the game control method includes an operation target control step of moving an operation target of a user in the game space, based on an operation by the user, a first determination step of determining whether or not the operation target of the user is included in a target region set based on a position of the game event occurring place, a second determination step of determining whether or not a time of determination that the operation target of the user is included in the target region is before arrival of the game event occurring time, and an inducing processing execution step of executing inducing processing for inducing the user to keep the operation target of the user staying in the target region until the arrival of the game event occurring time, in a case where it is determined that the time of determination that the operation target of the user is included in the target region is before the arrival of the game event occurring time.

Further, a program according to the present invention is a program for causing a computer, such as, for example, a consumer game device (an installation type game device), a portable game device, a commercial game device, a portable phone, a portable information terminal, a personal computer, a server computer, or the like, to function as a game device for executing a game in which a predetermined game event occurs at a game event occurring place set in a game space in a case where a game event occurring time arrives, the program for causing the computer to function as operation target control means for moving an operation target of a user in the game space, based on an operation by the user, first determination means for determining whether or not the operation target of the user is included in a target region set based on a position of the game event occurring place, second determination means for determining whether or not a time of determination that the operation target of the user is included in the target region is before arrival of the game event occurring time, and inducing processing execution means for executing inducing processing for inducing the user to keep the operation target of the user staying in the target region until the arrival of the game event occurring time, in a case where it is determined that the time of determination that the operation target of the user is included in the target region is before the arrival of the game event occurring time.

A non-transitory computer readable information storage medium according to the present invention is a non-transitory computer readable information storage medium storing the above described program.

In one aspect of the present invention, the second determination means may include means for determining whether or not a remaining period of time after the time of determination that the operation target of the user is included in the target region before the arrival of the game event occurring time is larger than a threshold, and the inducing processing execution means may execute the inducing processing, in a case where it is determined that the remaining period of time after the time of determination that the operation target of the user is included in the target region before the arrival of the game event occurring time is larger than the threshold.

In one aspect of the present invention, the inducing processing execution means may include means for starting outputting of sound, in the case where it is determined that the time of determination that the operation target of the user is included in the target region is before the arrival of the game event occurring time, and the inducing processing execution means may further include at least one of means for restricting outputting of the sound in a case where the operation target of the user leaves the target region to be outside thereof after start of outputting the sound, and means for restricting outputting of the sound after the start of outputting the sound, based on a distance between the operation target of the user and a reference position of the target region.

In one aspect of the present invention, the inducing processing execution means may include means for starting outputting of information on the game, in the case where it is determined that the time of determination that the operation target of the user is included in the target region is before the arrival of the game event occurring time, and the inducing processing execution means may further include at least one of means for restricting outputting of the information in a case where the operation target of the user leaves the target region to be outside thereof after start of outputting the information, and means for restricting outputting of the information after the start of outputting the information, based on a distance between the operation target of the user and a reference position of the target region.

In one aspect of the present invention, the inducing processing execution means may include means for starting outputting of a message, in the case where it is determined that the time of determination that the operation target of the user is included in the target region is before the arrival of the game event occurring time, and the inducing processing execution means may further include at least one of means for restricting outputting of the message, in a case where the operation target of the user leaves the target region to be outside thereof after start of outputting the message, and means for restricting outputting of the message after the start of outputting the message, based on a distance between the operation target of the user and a reference position of the target region.

In one aspect of the present invention, the inducing processing execution means may include means for placing a plurality of game items available for the operation target of the user to obtain in the target region, in the case where it is determined that the time of determination that the operation target of the user is included in the target region is before the arrival of the game event occurring time.

In one aspect of the present invention, the inducing processing execution means may change content of the inducing processing, based on a remaining period of time after the time of determination that the operation target of the user is included in the target region before the arrival of the game event occurring time.

In one aspect of the present invention, the first determination means may determine whether or not the operation target of the user arrives at the target region, the second determination means may determine whether or not a time of the arrival of the operation target of the user at the target region is before the arrival of the game event occurring time, and the inducing processing execution may execute the inducing processing in the case where it is determined that the time of the arrival of the operation target of the user at the target region is before the arrival of the game event occurring time.

### Advantageous Effects of Invention

According to the present invention, it is possible to induce a user to keep a user operation target in a game event occurring place until arrival of a game event occurring time, in a case where the user operation target arrives at the game event occurring place before the arrival of the game event occurring time.

### BRIEF DESCRIPTION OF DRAWINGS

FIG. 1 shows one example of a hardware structure of a game device according to an embodiment of the present invention;

FIG. 2 shows one example of a game space;

FIG. 3 explains a function of the game device;

FIG. 4 is a functional block diagram of the game device;

FIG. 5 shows one example of correlation between a distance and a volume;

FIG. 6 is a flowchart of one example of processing executed in the game device;

FIG. 7 is a flowchart of another example of processing executed in the game device;

FIG. 8 shows one example of correlation between a distance and transparency;

FIG. 9 shows one example of correlation between a period of time and inducing processing; and

FIG. 10 shows one example of a structure of a game system according to another embodiment of the present invention.

### DESCRIPTION OF EMBODIMENTS

In the following, an example of an embodiment of the present invention will be described in detail with reference to the accompanying drawings. A game device according to an embodiment of the present invention is implemented using, for example, a consumer game device (an installation type game device), a portable game device, a commercial game device, a portable phone (including a smart phone), a portable information terminal (a tablet-type computer), a personal computer, a server computer, or the like.

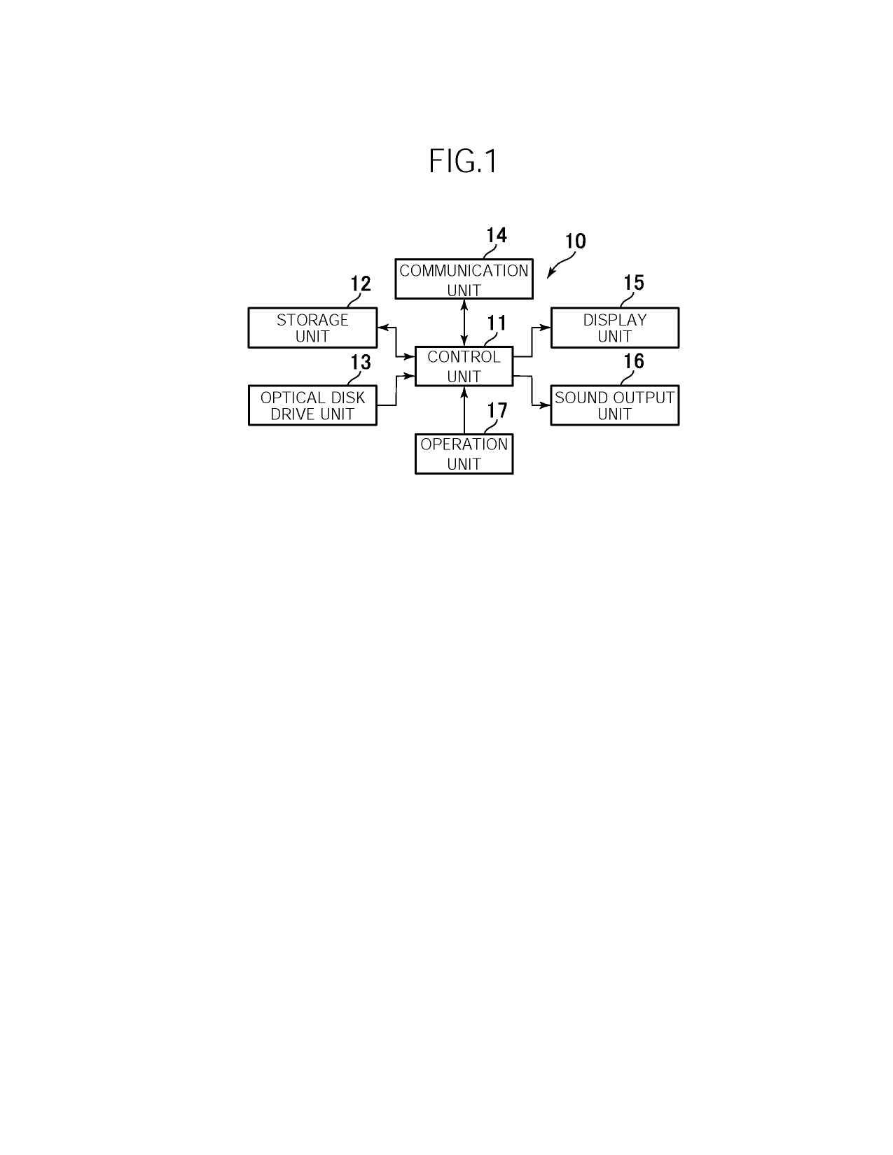

FIG. 1 shows one example of a hardware structure of a game device according to an embodiment of the present invention. As shown in FIG. 1, a game device 10 includes a control unit 11, a storage unit 12, an optical disk drive unit 13, a communication unit 14, a display unit 15, a sound output unit 16, and an operation unit 17.

The control unit 11 includes, for example, one or more microprocessors. The control unit 11 executes processing for controlling the respective units of the game device 10 or information processing, based on a program stored in the storage unit 12 or an optical disk.

The storage unit 12 includes a main memory unit and an auxiliary storage unit. The main memory unit includes, for example, a RAM, and a program and data read from the auxiliary storage unit or an optical disk is written into the main memory unit. The main memory unit is used also as a working memory of the control unit 11. The auxiliary storage unit is, for example, a nonvolatile storage medium, such as a hard disk drive, a solid state drive, or the like, and a program and data are stored in the auxiliary storage unit.

The optical disk drive unit 13 is for reading a program and data stored in an optical disk (an information storage medium). The program and data is supplied via an optical disk to the game device 10, and stored in the storage unit 12. Note that the game device 10 may include a structural element for reading a program and data stored in an information storage medium other than an optical disk. For example, the game device 10 may include a memory card slot unit. The memory card slot unit is for reading a program and data stored in a memory card (an information storage medium). A program and data may be supplied via a memory card to the game device 10, and stored in the storage unit 12.

The communication unit 14 is for data communication via a communication network, such as the Internet, or the like. For example, a program and data may be supplied via a communication network from a remote place to the game device 10 to be stored in the storage unit 12.

The display unit 15 is, for example, a liquid crystal display or an organic EL display. The display unit 15 displays a screen according to an instruction from the control unit 11. The sound output unit 16 is, for example, a speaker or a headphone. The sound output unit 16 outputs sound (for example, music or sound effects) according to an instruction from the control unit 11.

The operation unit 17 is used for a user operation. The operation unit 17 includes one or more operating members for receiving the user operation. For example, the operation unit 17 includes at least one of a button, a key, and a stick (a lever). Further, for example, the operation unit 17 includes a pointing device, such as a touch panel, a mouse, or the like.

In the above-described game device 10, various games are executed. In the following, a case will be described in which a game in which a game character operated by a user (hereinafter referred to as a “user character”) moves in a game space (a virtual world) is executed in the game device 10.

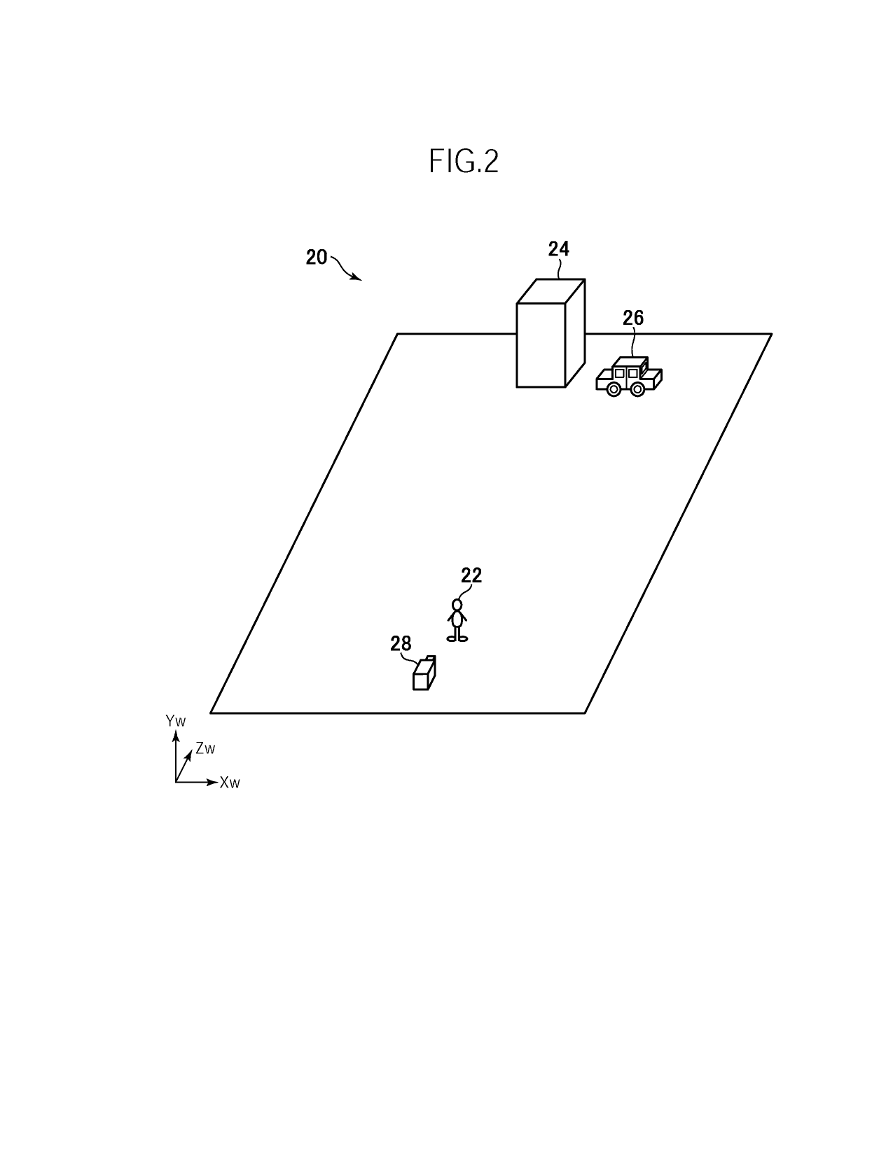

In the game device 10, a game space is created in the main memory unit. FIG. 2 shows one example of the game space. The game space 20 shown in FIG. 2 is a virtual 3D space defined by three mutually orthogonal coordinate axes (Xw axis, Yw axis, and Zw axis). FIG. 2 shows a part of the game space 20. Note that the game space may be a virtual 2D space defined by two mutually orthogonal coordinate axes.

In the game space 20 shown in FIG. 2, an object representing a user character 22, an object representing a building 24, and an object representing an automobile 26 are placed. The user character 22 acts according to a user operation. The automobile 26 is parking near the building 24.

A virtual camera 28 (a viewpoint) is set in the game space 20. Then, a game screen showing the game space 20 viewed from the virtual camera 28 is displayed on the display unit 15.

The virtual camera 28 is set based on the position of the user character 22, and moves according to the moving of the user character 22. For example, the virtual camera 28 is set behind above the user character 22. Note that the virtual camera 28 may be set in a position within the head portion of the user character 22 (for example, at the middle position between the left eye and the right eye). In this case, the field of view of the virtual camera 28 is substantially the same as that of the user character 22.

In the above-described game, at arrival of a game event occurring time, a predetermined game event occurs at a game event occurring place set in the game space 20. For example, in the above described game, a game event (for example, an explosion) occurs in the building 24.

With the above-described game, there may be a case in which the user character 22 arrives near the building 24 before the arrival of the game event occurring time. Then, there may be a case in which the user character 22 already leaves the building 24 before the arrival of the game event occurring time. In such a case, as the user character 22 is no longer present near the building 24 at the game event occurring time, a game event involving the building 24 is not displayed in a game screen. That is, the user cannot see the game event involving the building 24, and thus not be aware of the game event.

Regarding this point, the game device 10 has a function for inducing a user to keep the user character 22 staying near the building 24 until the arrival of the game event occurring time in the above described case.

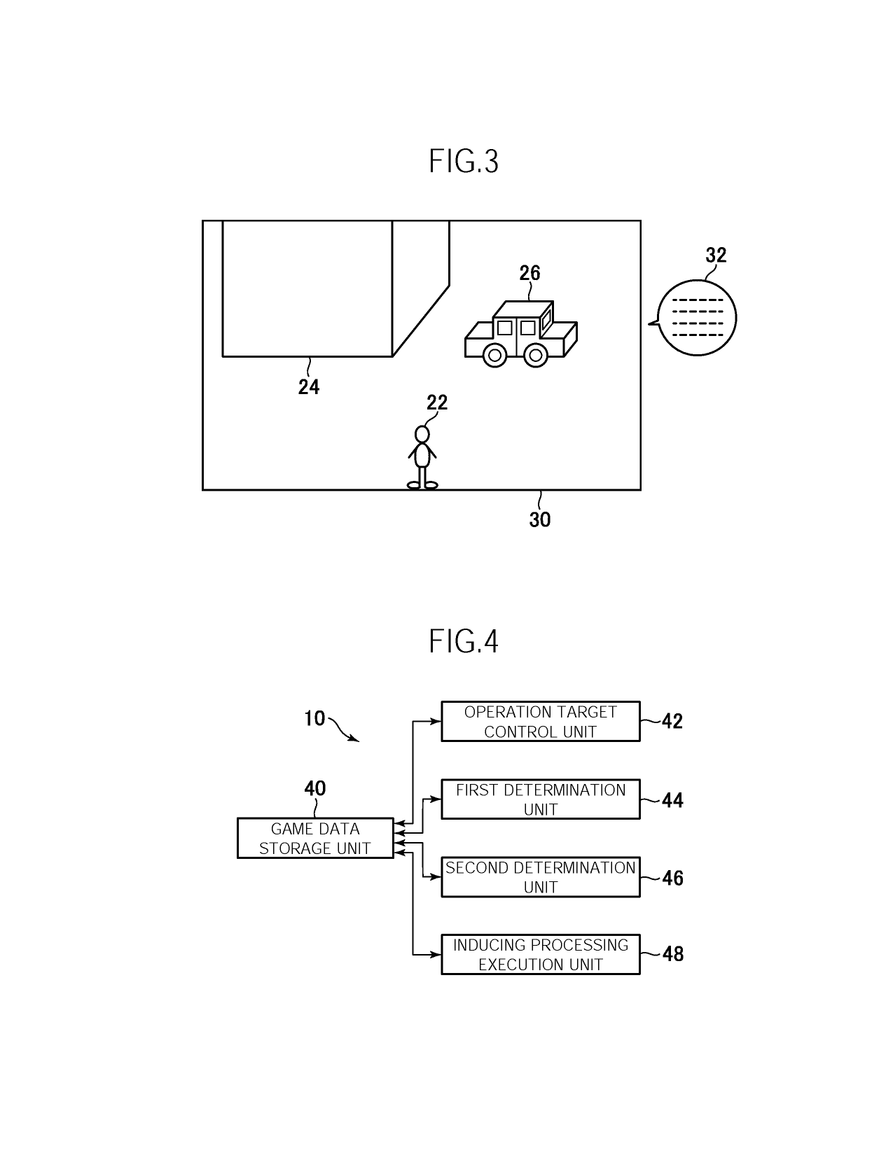

FIG. 3 explains the above described function. As the building 24 and the automobile 26 come to be included in the viewing field of the virtual camera 28 in a case where the user character 22 is arriving near the building 24, the building 24 and the automobile 26 are displayed in the game screen 30, as shown in FIG. 3.

In the game device 10, in particular, in a case where the user character 22 arrives at a region near the building 24 before the arrival of the game event occurring time, sound 32 representing sound coming from a radio placed in the automobile 26 parking near the building 24 is output from the sound output unit 16.

Sound that attracts attention of a user is output from the radio. For example, a voice of an announcer informing a user of information on a game is output. Specifically, a voice of an announcer informing a user of hint information to clear a game is output.

Output of the above-described sound continues until at least the arrival of the game event occurring time. However, if the user character 22 leaves the region near the building 24 to be outside thereof, output of the above-described sound stops. For example, as the distance between the user character 22 and the automobile 26 becomes larger, the volume of the above-described sound becomes gradually smaller. Then, in a case where the distance between the user character 22 and the automobile 26 exceeds a threshold, it is considered that the user character 22 has left the region near the building 24 to be outside thereof, and therefore, the output of the above-described sound stops.

With the above described sound being output, a user keeps the user character 22 staying near the automobile 26 (that is, a region near the building 24) until the arrival of the game event occurring time in order to hear the above-described sound. That is, in the game device 10, outputting the above described sound enables to induce the user to keep the user character 22 staying in the region near the building 24 (the game event occurring place) until the arrival of the game event occurring time.

Note that instead of outputting sound coming from the radio placed in the automobile 26, for example, sound coming from another game character located near the building 24 may be output. Further, instead of outputting game information from a radio, game music may be output from the radio. For example, special game music may be output from the radio.

Below, a structure for implementing the above described function will be described. FIG. 4 is a functional block diagram showing a functional block implemented in the game device 10. As shown in FIG. 4, the game device 10 includes a game data storage unit 40, an operation target control unit 42, a first determination unit 44, a second determination unit 46, and an inducing processing execution unit 48.

For example, the game data storage unit 40 is implemented by the storage unit 12 or an optical disk, while the other functional blocks are implemented by the control unit 11. That is, the control unit 11 executes processing according to a program stored in the storage unit 12 or an optical disk, thereby functioning as functional blocks other than the game data storage unit 40.

Initially, the game data storage unit 40 will be described. The game data storage unit 40 stores data necessary for executing a game. For example, shape data or the like on each of the objects placed in the game space 20 is stored in the game data storage unit 40.

Further, for example, data (game state data) describing the current state of the game space 20 is stored in the game data storage unit 40. The game state data includes, for example, data describing a state of each of the objects placed in the game space 20. Specifically, data describing a state (a position or the like) of the user character 22 is included in the game state data.

Further, for example, data on a game event is stored in the game data storage unit 40. That is, data on a game event occurring place and a game event occurring time is stored in the game data storage unit 40.

Below, the operation target control unit 42 will be described. The operation target control unit 42 moves a user operation target (an operation target of the user) in the game space, based on a user operation. In the above described game, as the user character 22 corresponds to the “user operation target”, the operation target control unit 42 moves the user character 22 in the game space 20, based on the user operation.

Below, the first determination unit 44 will be described. The first determination unit 44 determines whether or not a user operation target is included in a target region that is set based on the position of a game event occurring place. For example, the first determination unit 44 determines whether or not the user operation target has arrived at the target region.

Note here that the “target region” refers to a region near the game event occurring place. For example, a region having the distance from the game event occurring place being smaller than a threshold (a reference distance) is defined as the “region near the game event occurring place”. In the above described game, as the building 24 corresponds to the “game event occurring place”, the first determination unit 44 determines whether or not the user character 22 is included in a region near the building 24. For example, the first determination unit 44 determines whether or not the user character 22 has arrived at the region near the building 24.

Below, the second determination unit 46 will be described. The second determination unit 46 determines whether or not the time of determination that the user operation target is included in the target region is before arrival of a game event occurring time. For example, in a case where it is determined that the user operation target is included in the target region, the second determination unit 46 determines whether or not the current time is before the arrival of the game event occurring time. Further, for example, the second determination unit 46 determines whether or not the time of the arrival of the user operation target at the target region is before the arrival of the game event occurring time.

In the above described game, the second determination unit 46 determines whether or not the time of determination that the user character 22 is included in the region near the building 24 (for example, a time at which the user character 22 arrives at the region near the building 24) is before the arrival of the game event occurring time.

Below, the inducing processing execution unit 48 will be described. The inducing processing execution unit 48 executes inducing processing in a case where it is determined that the time of determination that the user operation target is included in the target region (for example, the time of the arrival of the user operation target at the target region) is before the arrival of the game event occurring time.

Note here that the “inducing processing” refers to processing for inducing the user to keep the user operation target staying in the target region until the arrival of the game event occurring time.

For example, the “inducing processing” is processing of outputting sound. For example, the inducing processing execution unit 48 executes processing of outputting sound coming from a sound source in the target region as the inducing processing. In the above described game, the automobile 26 (radio) corresponds to the “sound source”.

Note here that the “sound” is a sound for inducing the user to keep the user operation target staying in the target region until the arrival of the game event occurring time, being a sound that attracts attention of the user.

For example, the “sound” is a sound via which to inform the user of information on the game. The “information on the game” refers to information that is useful for the user playing the game. For example, information for clearing the game corresponds to the “information on the game”. For example, information on a place to go in order to clear the game or information on an item need to be obtained in order to clear the game corresponds to the “information on the game”.

Further, the “information on the game” may be information not indispensable in order to clear the game. For example, “information on the game” may be information on a place not necessarily to go in order to clear the game or information on an item not necessarily to be obtained in order to clear the game.

The “sound” may be the sound of a message to the user. Note here that the “message” may be either relevant or irrelevant to the game.

Further, the “sound” may be game music. For example, the “sound” may be game music specially composed so as to attract attention of the user.

Further, in a case where the user operation target leaves the target region to be outside thereof after start of outputting the above-described sound, the inducing processing execution unit 48 restricts (for example, to stop) outputting of the above-described sound. Specifically, as long as the user operation target remains in the target region, the inducing processing execution unit 48 keeps outputting the sound at a constant volume. Then, in the case where the user operation target leaves the target region to be outside thereof, the inducing processing execution unit 48 stops outputting the sound.

Note that the inducing processing execution unit 48 may restrict outputting of the above described sound after start of outputting of the sound, based on the distance between the user operation target and a reference position of the target region. Note here that the “reference position of the target region” may be, for example, the position of a sound source or the position of the game event occurring place. For example, in the above described game, the position of the automobile 26 (sound source) or the position of the building 24 (the game event occurring place) corresponds to the “reference position of the target region”.

For example, the inducing processing execution unit 48 reduces the volume of the above described sound gradually as the above-described distance becomes larger. Then, when the above-described distance exceeds a threshold, the inducing processing execution unit 48 considers that the user operation target has left the target region to be outside thereof, and thus stops outputting the above-described sound. Note here that “to stop outputting the sound” includes being not executing sound output itself and setting the volume of the sound to zero.

FIG. 5 shows one example of correlation between the distance (d) between the user operation target and the reference position of the target region and the volume (v) of the above-described sound. In FIG. 5, “D1”, “D2”, and “D3” are each a predetermined distance, and hold “D1<D2<D3”. “V1”, “V2”, and “V3” are each a predetermined volume, and hold “0<V1<V2<V3”. According to the correlation shown in FIG. 5, as the distance (d) becomes larger, the volume (v) becomes smaller. The inducing processing execution unit 48 sets the volume of the above-described sound, based on the distance (d) between the user operation target and the reference position of the target region and the correlation shown in FIG. 5.

Note that although the correlation between the above-described distance (d) and the above-described volume (v) is shown as information in a table format in FIG. 5, the correlation between the above-described distance (d) and the above-described volume (v) may be expressed in an expression format.

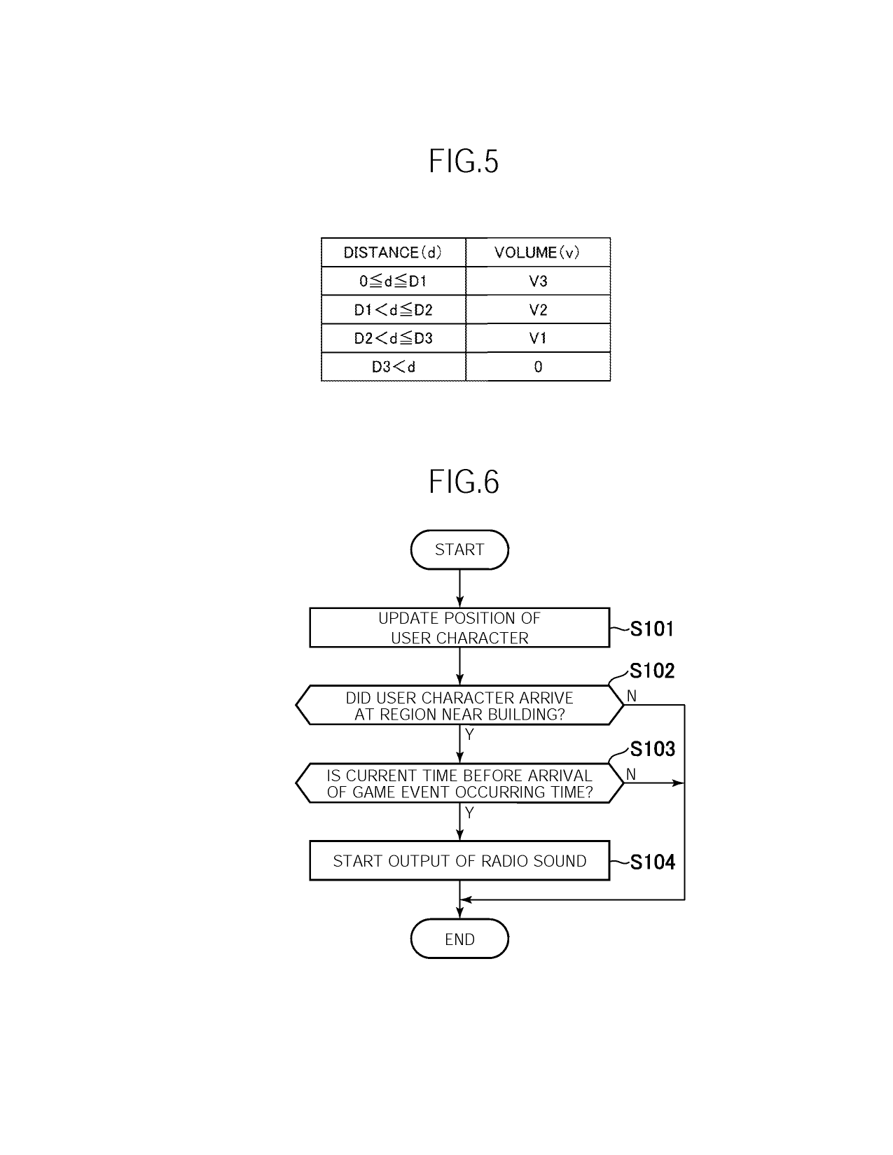

In the following, processing executed in the game device 10 to implement the above-described functional block will be described. FIG. 6 is a flowchart mainly showing processing for implementing the above described functional blocks among processing executed in the game device 10. FIG. 6 shows one example of processing for inducing the user to keep the user character 22 staying near the building 24 until the arrival of the game event occurring time in the case where the user character 22 arrives near the building 24 before the arrival of the game event occurring time. Note that the processing shown in FIG. 6 is executed for every predetermined period of time (for example, 1/60^{th} of a second).

The control unit 11 executes the processing shown in FIG. 6 according to the program, thereby functioning as the operation target control unit 42, the first determination unit 44, the second determination unit 46, and the inducing processing execution unit 48.

As shown in FIG. 6, the control unit 11 (the operation target control unit 42) updates the position of the user character 22, based on a user operation (S101). For example, the control unit 11 updates the position of the user character 22, based on the direction designated through a movement direction designating operation.

Thereafter, the control unit 11 (the first determination unit 44) determines whether or not the user character 22 has arrived a region near the building 24 (S102). In a case where it is determined that the user character 22 has not arrived the region near the building 24, this processing is terminated. Meanwhile, in a case where it is determined that the user character 22 has arrived the region near the building 24, the control unit 11 (the second determination unit 46) determines whether or not the current time is before the arrival of the game event occurring time (S103).

In a case where it is determined that the current time is not before the arrival of the game event occurring time, this processing is terminated. Meanwhile, in a case where it is determined that the current time is before the arrival of the game event occurring time, the control unit 11 (the inducing processing execution unit 48) starts outputting sound coming from the radio placed in the automobile 26 (S104).

In this case, the control unit 11 reads sound data on the sound coming from the radio placed in the automobile 26 from the game data storage unit 40, and reproduces the sound data. Further, in this case, the control unit 11 sets the volume of the sound coming from the radio, based on the distance (d) between the user character 22 and the automobile 26 and the correlation shown in FIG. 5.

Note that after start of outputting the sound coming from the radio, the control unit 11 sets the volume of the sound for every predetermined period of time (for example, 1/60^{th} of a second). That is, the control unit 11 obtains the distance (d) between the user character 22 and the automobile 26 for every predetermined period of time, and sets the volume of the sound coming from the radio, based on the distance (d) and the correlation shown in FIG. 5.

According to the above described game device 10, when the user character 22 arrives the region near the building 24 before the arrival of the game event occurring time, it is possible by outputting the above-described sound (for example, sound coming from the radio) to induce the user to keep the user character 22 staying in the region near the building 24 (the game event occurring place) until the arrival of the game event occurring time.

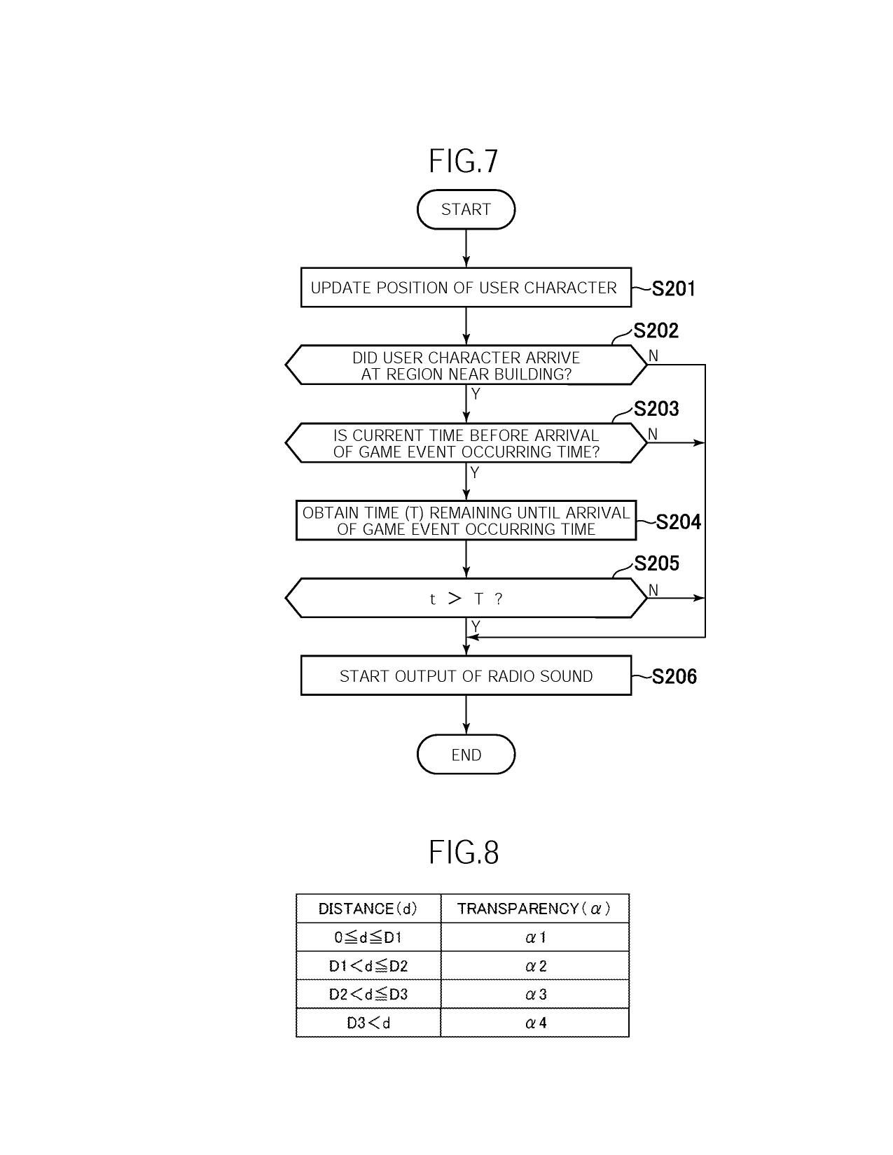

Note that the present invention is not limited to the above-described embodiment.

[1] For example, instead of the processing shown in FIG. 6, the processing shown in FIG. 7 may be executed. Note that step S201 to S203 in FIG. 7 are similar to steps S101 to S103 in FIG. 6, and thus not described here.

In the processing shown in FIG. 7, in the case where it is determined at step S203 that the current time is before the arrival of the game event occurring time, the control unit 11 obtains a period of time (t) remaining before the arrival of the game event occurring time (S204). Then, the control unit 11 (the second determination unit 46) determines whether or not the above-described period of time (t) is larger than a threshold (T) (S205).

In a case where it is determined that the above-described period of time (t) is not larger than the threshold (T), this processing is terminated. Meanwhile, in a case where it is determined that the above-described period of time (t) is larger than the threshold (T), the control unit 11 (the inducing processing execution unit 48) starts outputting sound coming from the radio placed in the automobile 26 (S206). Step S206 is similar to step S104 in FIG. 5.

As described above, the second determination unit 46 may determine whether or not the remaining period of time after a time at which it is determined that the user character 22 (the user operation target) is included in the region near the building 24 (the target region) (for example, a time at which the user character 22 arrives at the region near the building 24) before the arrival of the game event occurring time is larger than a threshold. Then, only upon determination that the above-described remaining period of time is larger than the threshold, the inducing processing execution unit 48 may execute the inducing processing.

When the above-described remaining period of time is smaller, it is highly likely that the user character 22 remains in the region near the building 24 until the arrival of the game event occurring time, and thus necessity of executing the inducing processing is low. Regarding this point, in the above described manner, only when the necessity of executing the inducing processing is not low, the inducing processing execution unit 48 executes the inducing processing. As a result, it is possible to reduce a processing load.

[2] Further, for example, the inducing processing is not limited to processing of outputting sound, but may be processing of displaying a text (or an image) in the game screen 30 (on the display unit 15).

That is, instead of outputting sound of the radio placed in the automobile 26 from the sound output unit 16, the inducing processing execution unit 48 may display a text (or an image) representing the sound coming from the above-described radio in the game screen 30. That is, the inducing processing execution unit 48 may display a text describing information on the game (or an image representing information on the game) in the game screen 30 or a text (or an image) representing a message in the game screen 30. Alternatively, the inducing processing execution unit 48 may display a text (or an image) representing a lyric of game music in the game screen 30.

In this case, the inducing processing execution unit 48 may erase the above-described text (or the image) in the game screen 30 in the case where the user character 22 leaves the region near the building 24 to be outside thereof.

Further, the inducing processing execution unit 48 may restrict displaying the above described text (or image), based on the distance (d) between the user character 22 (the user operation target) and the automobile 26 (the reference position of the target region). That is, the inducing processing execution unit 48 may enhance transparency of the above describes text (or the image), based on the distance (d) between the user character 22 and the automobile 26. For example, the inducing processing execution unit 48 may gradually enhance the transparency of the above described text (or the image) as the above-described distance (d) becomes larger. Then, when the above-described distance (d) exceeds the reference distance, the inducing processing execution unit 48 may consider that the user character 22 has left the near the building 24 to be outside thereof, and then erase the above-described text (or the image) in the game screen 30.

FIG. 8 shows one example of correlation between the distance (d) between the user character 22 and the automobile 26 and the transparency (a) of the text or the image, wherein “D1”, “D2”, and “D3” are similar to those in FIG. 5. Further, “α1”, “α2”, “α3”, and “α4” are each of predetermined transparency, and hold “α1<α2<α3<α4”. Note that “α1” means being fully opaque; “α4” means being thorough transparent. The inducing processing execution unit 48 sets the transparency of the above described text (or the image), based on the distance (d) between the user character 22 and the automobile 26 and the correlation shown in FIG. 8.

Note that although the correlation between the above-described distance (d) and the above-described transparency (α) is shown in a table format in FIG. 8, the correlation between the above-described distance (d) and the above-described transparency (a) may be expressed in an expression format.

[3] Further, for example, the inducing processing may be processing of placing in the target region a plurality of game items available for the user operation target to obtain.

That is, in the case where it is determined that a time of determination that the user character 22 is included in the region near the building 24 (for example, a time of arrival of the user character 22 at the region near the building 24) is before the arrival of the game event occurring time, the inducing processing execution unit 48 may place a plurality of game items available for the user character 22 to obtain in the region near the building 24.

In this case, the number of game items to be placed in the region near the building 24 is set such that a period of time necessary to obtain all of the game items is equal to or larger than the remaining period of time before the arrival of the game event occurring time.

In the above described manner, it is possible to induce the user to obtain the game items scattered in the region near the building 24. Then, as a result, it is possible to induce the user to keep the user character 22 staying in the region near the building 24 until the arrival of the game event occurring time.

[4] Further, the inducing processing execution unit 48 may change content of the inducing processing, based on the remaining period of time after a time of determination that the user character 22 is included in the region near the building 24 (for example, a time of the arrival of the user character 22 at the region near the building 24) before the arrival of the game event occurring time.

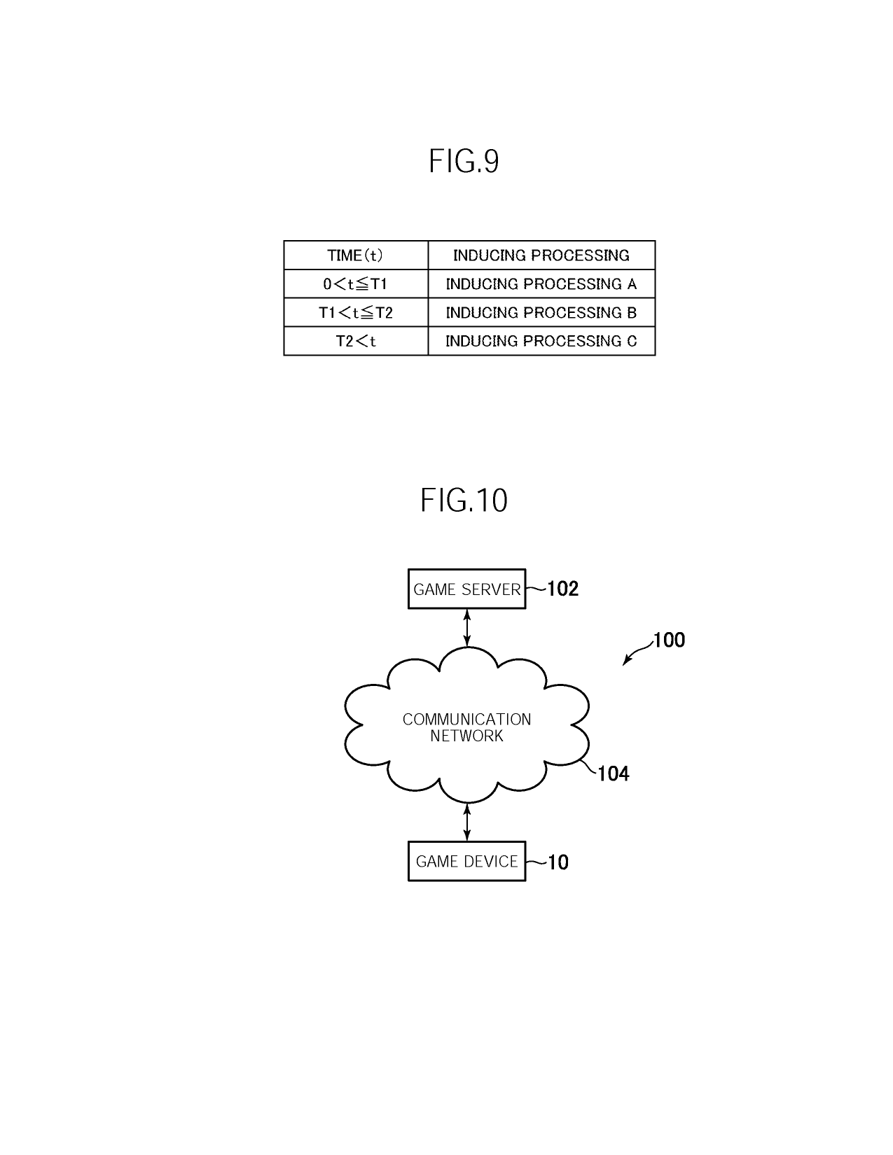

FIG. 9 shows one example of correlation between the remaining period of time (t) after a time of the arrival of the user character 22 at the region near the building 24 before the arrival of the game event occurring time, and the inducing processing, wherein “T1” and “T2” each refer to a predetermined period of time, and hold “T1<T2”. Further, according to the correlation shown in FIG. 9, “inducing processing A” is correlated to the range “0<t≦T1” of the remaining period of time (t). Similarly, “inducing processing B” is correlated to the range “T1<t≦T2” of the remaining period of time (t); “inducing processing C” is correlated to the range “T2<t” of the remaining period of time (t).

For example, the inducing processing A to C is processing of outputting sound representing information on the game from the sound output unit 16, as sound coming from a radio placed in the automobile 26. Note that the contents of sounds mutually differ from one another among the inducing processings A to C. In other words, a period of time (a reproduction period) necessary to complete sound reproduction differs from one another among inducing processings A to C.

For example, in a case where a remaining period of time (t) is relatively long, processing of outputting sound with a relatively long reproduction period is executed as the inducing processing. Meanwhile, in a case where a remaining period of time (t) is relatively short, processing of outputting sound with a relatively short reproduction period is executed as the inducing processing. In the example shown in FIG. 9, for example, supposing that the reproduction periods for the sounds output in the respective inducing processings A, B, C are defined as TA, TB, TC, the inducing processings A to C are set such that TA to TC hold “TA<TB<TC”.

Further, for example, the inducing processings A to C are all processing of displaying in the game screen 30 a text representing information on the game as sound coming from a radio placed in the automobile 26. However, contents of the texts differ from one another among the inducing processings A to C. In other words, the lengths of the texts differ from one another among the inducing processing A to C.

For example, in a case where a remaining period of time (t) is relatively long, processing of outputting a relatively long text is executed as the inducing processing. Meanwhile, in a case where a remaining period of time (t) is relatively short, processing of outputting a relatively short text is executed as the inducing processing. In the example shown in FIG. 9, for example, supposing that the lengths of the texts displayed in the respective inducing processings A, B, C are defined as LA, LB, LC, the inducing processings A to C are set such that LA to LC hold “LA<LB<LC”.

Further, for example, the inducing processings A to C are all processing of placing a plurality of game items available for the user character 22 to obtain in the region near the building 24. However, the number of game items to be placed in the region near the building 24 differs from one another among the inducing processings A to C.

For example, in a case where a remaining period of time (t) is relatively long, processing of placing a relatively large number of game items in the region near the building 24 is executed as the inducing processing. Meanwhile, in a case where a remaining period of time (t) is relatively short, processing of placing a relatively small number of game items in the region near the building 24 is executed as the inducing processing. For example, in the example shown in FIG. 9, supposing that the numbers of game items to be placed in the respective inducing processings A, B, C are defined as NA, NB, NC, the inducing processings A to C are set such that NA to NC hold “NA<NB<NC”.

In the above described manner, it is possible to execute the optimum inducing processing, based on the remaining period of time after a time of determination that the user character 22 is included in the region near the building 24 (for example, a time of the arrival of the user character 22 at the region near the building 24) before the arrival of the game event occurring time.

Note that the types of the inducing processings A to C may differ from one another. For example, the inducing processings A, B may be processing of outputting sound coming from the sound output unit 16, while the inducing processing C may be processing of placing a plurality of game items available for the user character 22 to obtain in the region near the building 24.

Further, the above described modified example 4 may be combined with the above described modified example 1. That is, when the above-described remaining period of time (t) is equal to or smaller than a predetermined period of time (T1), the inducing processing may not be executed. That is, the inducing processing A in FIG. 9 may be omitted.

[5] Further, for example, the present invention may be applicable to a game system 100 such as is shown in FIG. 10. The game system 100 shown in FIG. 10 includes a game device 10 and a game server 102. The game server 102 is a server computer having, for example, a control unit and the like. In the game system 100, the game device 10 and the game server 102 exchange data via the communication network 104 to execute a game.

For example, in the game system 100, game state data is stored in the storage unit of the game server 102 or a storage unit of a device accessible from the game server 102. Then, the game state data is updated by the game server 102.

Specifically, in the game system 100, data on an operation performed in the game device 10 is sent form the game device 10 to the game server 102. In the game server 102, the game state data is updated based on the data sent from the game device 10. Then, the updated game state data is sent from the game server 102 to the game device 10. In the game device 10, the game screen 30 is displayed on the display unit 15 based on the data sent from the game server 102.

In the game system 100, for example, the operation target control unit 42 is implemented in the game server 102, and the first determination unit 44, the second determination unit 46, and the inducing processing execution unit 48 are implemented in the game device 10. In this case, the first determination unit 44, the second determination unit 46, and the inducing processing execution unit 48 execute processing based on the updated game state data sent from the game server 102 to the game device 10.

Note that the first determination unit 44 also may be implemented in the game server 102. In this case, data on a result of determination by the first determination unit 44 may be sent from the game server 102 to the game device 10.

Further, the second determination unit 46 also may be implemented in the game server 102. In this case, data on a result of determination by the second determination unit 46 may be sent from the game server 102 to the game device 10.

Further, the inducing processing execution unit 48 also may be implemented in the game server 102. For example, like the above described modified example 3, in a case where the processing for placing a plurality of game items available for the user operation target to obtain in the target region is executed as the inducing processing, the inducing processing execution unit 48 may be implemented in the game server 102.

Also, in a case where the processing of outputting sound, a text, and so forth, as the inducing processing, the inducing processing execution unit 48 may be implemented in the game server 102. In this case, the inducing processing execution unit 48 may send the game device 10 data to instruct output of sound, text, and so forth, when it is determined that the time of the arrival of the user operation target at the target region is before the arrival of the game event occurring time. Then, in the game device 10, sound, text, and so forth may be output based on the data.

Note that in the game system 100, in a case where the game state data is updated in the game server 102, the game server 102 may generate the game screen 30 based on the updated game state data. Then, data on the generated game screen 30 may be sent from the game server 102 to the game device 10.

[6] The present invention can be applied to a game other than the above described game. The present invention can be applied to a game in which a predetermined game event occurs at a game event occurring place set in the game space in a case where a game event occurring time arrives.

While there have been described what are at present considered to be certain embodiments of the invention, it will be understood that various modifications may be made thereto, and it is intended that the appended claims coverall such modifications as fall within the true spirit and scope of the invention.

What is claimed is:

1. A game device for executing a game in which a predetermined game event occurs at a game event occurring place set in a game space in a case where a game event occurring time arrives, comprising:
operation target control means for moving an operation target of a user in the game space, based on an operation by the user;
first determination means for determining whether or not the operation target of the user is included in a target region set based on a position of the game event occurring place;
second determination means for determining whether or not a time of determination that the operation target of the user is included in the target region is before arrival of the game event occurring timing; and
inducing processing execution means for executing inducing processing for inducing the user to keep the operation target of the user staying in the target region until the arrival of the game event occurring time, in a case where it is determined that the time of determination that the operation target of the user is included in the target region is before the arrival of the game event occurring time.

2. The game device according to claim 1, wherein
the second determination means includes means for determining whether or not a remaining period of time after the time of determination that the operation target of the user is included in the target region before the arrival of the game event occurring time is larger than a threshold, and
the inducing processing execution means executes the inducing processing, in a case where it is determined that the remaining period of time after the time of determination that the operation target of the user is included in the target region before the arrival of the game event occurring time is larger than the threshold.

3. The game device according to claim 1, wherein
the inducing processing execution means includes means for starting outputting of sound, in the case where it is determined that the time of determination that the operation target of the user is included in the target region is before the arrival of the game event occurring time, and
the inducing processing execution means further includes at least one of
means for restricting outputting of the sound in a case where the operation target of the user leaves the target region to be outside thereof after start of outputting the sound, and
means for restricting outputting of the sound after the start of outputting the sound, based on a distance between the operation target of the user and a reference position of the target region.

4. The game device according to claim 1, wherein
the inducing processing execution means includes means for starting outputting of information on the game, in the case where it is determined that the time of determination that the operation target of the user is included in the target region is before the arrival of the game event occurring time, and
the inducing processing execution means further includes at least one of
means for restricting outputting of the information in a case where the operation target of the user leaves the target region to be outside thereof after start of outputting the information, and
means for restricting outputting of the information after the start of outputting the information, based on a distance between the operation target of the user and a reference position of the target region.

5. The game device according to claim 1, wherein
the inducing processing execution means includes means for starting outputting of a message, in the case where it is determined that the time of determination that the operation target of the user is included in the target region is before the arrival of the game event occurring time, and
the inducing processing execution means further includes at least one of
means for restricting outputting of the message in a case where the operation target of the user leaves the target region to be outside thereof after start of outputting the message, and
means for restricting outputting of the message after the start of outputting the message, based on a distance between the operation target of the user and a reference position of the target region.

6. The game device according to claim 1, wherein the inducing processing execution means includes means for placing a plurality of game items available for the operation target of the user to obtain in the target region, in the case where it is determined that the time of determination that the operation target of the user is included in the target region is before the arrival of the game event occurring time.

7. The game device according to claim 1, wherein the inducing processing execution means changes content of the inducing processing, based on a remaining period of time after the time of determination that the operation target of the user is included in the target region before the arrival of the game event occurring time.

8. The game device according to claim 1, wherein
the first determination means determines whether or not the operation target of the user arrives at the target region,
the second determination means determines whether or not a time of the arrival of the operation target of the user at the target region is before the arrival of the game event occurring time, and
the inducing processing execution means executes the inducing processing in a case where it is determined that the time of the arrival of the operation target of the user at the target region is before the arrival of the game event occurring time.

9. A game system for executing a game in which a predetermined game event occurs at a game event occurring place set in a game space in a case where a game event occurring time arrives, comprising:
operation target control means for moving an operation target of a user in the game space, based on an operation by the user;
first determination means for determining whether or not the operation target of the user is included in a target region set based on a position of the game event occurring place;
second determination means for determining whether or not a time of determination that the operation target of the user is included in the target region is before arrival of the game event occurring time; and
inducing processing execution means for executing inducing processing for inducing the user to keep the operation target of the user staying in the target region until the arrival of the game event occurring time, in a case where it is determined that the time of determination that the operation target of the user is included in the target region is before the arrival of the game event occurring time.

10. A game control method for a game in which a predetermined game event occurs at a game event occurring place set in a game space in a case where it is determined that a game event occurring time arrives, comprising:
an operation target control step of moving an operation target of a user in the game space, based on an operation by the user;
a first determination step of determining whether or not the operation target of the user is included in a target region set based on a position of the game event occurring place;
a second determination step of determining whether or not a time of determination that the operation target of the user is included in the target region is before arrival of the game event occurring time; and
an inducing processing execution step of executing inducing processing for inducing the user to keep the operation target of the user staying in the target region until the arrival of the game event occurring time, in a case where it is determined that the time of determination that the operation target of the user is included in the target region is before the arrival of the game event occurring time.

11. A non-transitory computer readable information storage medium storing a program for causing a computer to function as a game device for executing a game in which a predetermined game event occurs at a game event occurring place set in a game space in a case where a game event occurring time arrives, the program for causing the computer to function as:
operation target control means for moving an operation target of a user in the game space, based on an operation by the user;
first determination means for determining whether or not the operation target of the user is included in a target region set based on a position of the game event occurring place;
second determination means for determining whether or not a time of determination that the operation target of the user is included in the target region is before arrival of the game event occurring time; and
inducing processing execution means for executing inducing processing for inducing the user to keep the operation target of the user staying in the target region until the arrival of the game event occurring timing, in a case where it is determined that the time of determination that the operation target of the user is included in the target region is before the arrival of the game event occurring time.
